(19) United States
(12) Patent Application Publication
(10) Pub. No.: US 2023/0109571 A1
(43) Pub. Date: Apr. 6, 2023

(54) GAS DRYER

(71) Applicant: Mitsubishi Electric Corporation, Chiyoda-ku,Tokyo (JP)

(72) Inventor: Takenori KISHIGAMI, Chiyoda-ku, Tokyo (JP)

(73) Assignee: Mitsubishi Electric Corporation, Chiyoda-ku,Tokyo (JP)

(21) Appl. No.: 17/904,490

(22) PCT Filed: May 20, 2020
(86) PCT No.: PCT/JP2020/019896

§ 371 Date: Aug. 18, 2022

(51) Int. Cl. B01D 53/26; H02K 9/10; H02K 9/26

(52) U.S. Cl. CPC B01D 53/263; B01D 53/265; H02K 9/10; H02K 9/26; B01D 2256/16; B01D 2257/80; B01D 2259/40083; B01D 2259/402

(57) ABSTRACT

This gas dryer includes: a first drying tower having a first desiccant provided therein; and a second drying tower having a second desiccant provided therein. Either the first drying tower or the second drying tower is switched to a drying circuit side for drying hydrogen gas of an electric device, and another of the first drying tower or the second drying tower is switched to a reactivation circuit side for reactivating the first desiccant or the second desiccant provided therein. The gas dryer includes a cooler which is provided on the reactivation circuit side and which, with only supply of compressed air, generates air having such a temperature that can condense moisture in the gas on the reactivation circuit side.

### TECHNICAL FIELD

The present disclosure relates to a gas dryer.

### BACKGROUND ART

In a conventional gas dryer, a Peltier element which is comparatively low in cost and operable with only electricity is used for a cooling portion of a reactivation circuit (see, for example, Patent Document 1).

### CITATION LIST

### Patent Document

Patent Document 1: Japanese Laid-Open Patent Publication No. 2008-29092

### SUMMARY OF THE INVENTION

### Problems to be Solved by the Invention

Conventionally, hydrogen gas passes through the inside of the gas dryer and therefore explosion protection needs to be considered. Since the Peltier element is used by being directly attached to the cooling portion, it is difficult to provide the Peltier element outside an explosion protection specified area, and since the Peltier element itself does not have an explosion protection structure, the entire part including the attachment part needs to have a special structure with explosion protection considered, leading to a problem of cost increase.

The present disclosure has been made to solve the above problem, and an object of the present disclosure is to provide a gas dryer that enables cost reduction without the need of a special structure.

### Solution to the Problems

A gas dryer according to the present disclosure is a gas dryer for drying hydrogen gas of an electric device in which the hydrogen gas is sealed, the gas dryer including: a first drying tower having a first desiccant provided therein; and a second drying tower having a second desiccant provided therein. Either the first drying tower or the second drying tower is switched to a drying circuit side for drying the hydrogen gas of the electric device, and another of the first drying tower or the second drying tower is switched to a reactivation circuit side for reactivating the first desiccant or the second desiccant provided therein. The gas dryer includes a cooler which is provided on the reactivation circuit side and which, with supply of compressed air, generates air having a temperature that enables condensation of moisture in the hydrogen gas on the reactivation circuit side.

### Effect of the Invention

The gas dryer according to the present disclosure enables cost reduction without the need of a special structure.

### BRIEF DESCRIPTION OF THE DRAWINGS

FIG. 1 is a system diagram showing a gas dryer according to embodiment 1.

FIG. 2 is a system diagram showing the relationship between the gas dryer shown in FIG. 1 and a rotary electric machine.

FIG. 3 is a system diagram showing a gas dryer according to embodiment 2.

### DESCRIPTION OF EMBODIMENTS

### Embodiment 1

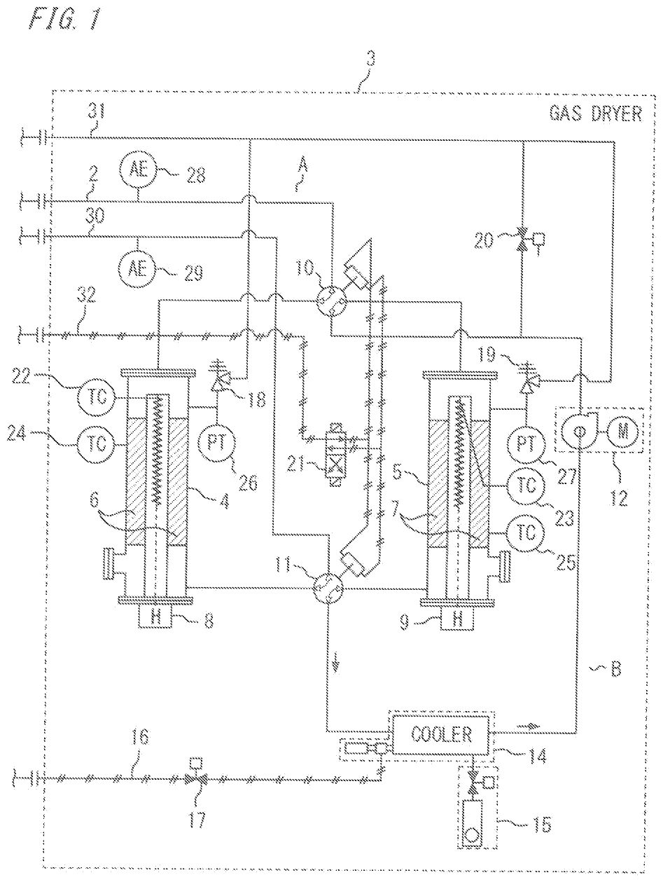

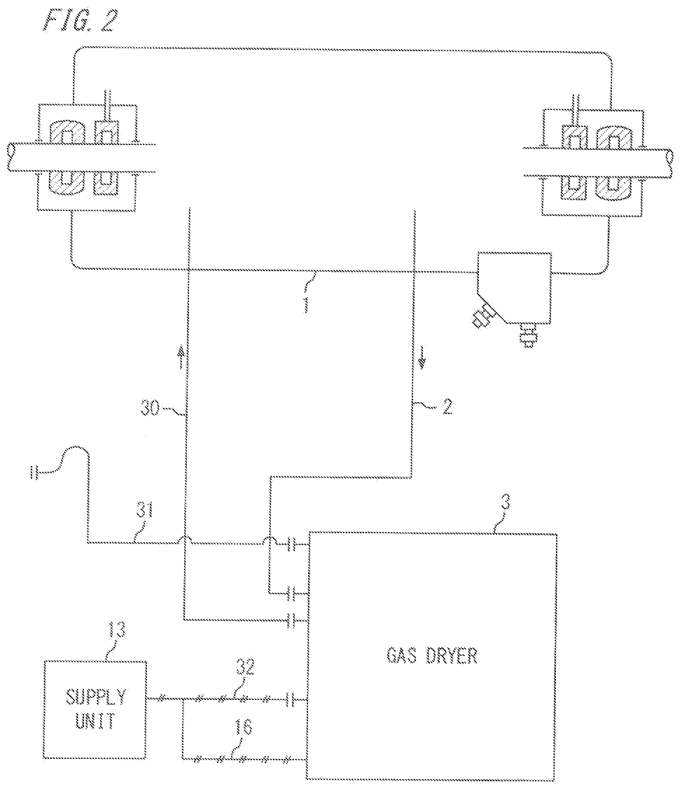

FIG. 1 is a system diagram showing a gas dryer according to embodiment 1. FIG. 2 is a system diagram showing the relationship between the gas dryer shown in FIG. 1 and a rotary electric machine. Hereinafter, embodiment 1 will be described with reference to the drawings. In FIG. 2, a gas dryer 3 is connected to a rotary electric machine 1 as an electric device via a first pipe 2 and a second pipe 30. Hydrogen gas for cooling is sealed in the rotary electric machine 1. The gas dryer 3 receives the hydrogen gas from the inside of the rotary electric machine 1 via the first pipe 2, dries the hydrogen gas, and then sends out the hydrogen gas into the rotary electric machine 1 via the second pipe 30.

The gas dryer 3 is a two-tower dryer and includes a first drying tower 4 and a second drying tower 5. A first desiccant 6 is provided in the first drying tower 4. A second desiccant 7 is provided in the second drying tower 5. In the gas dryer 3, either the first drying tower 4 or the second drying tower 5 is switched to a drying circuit side A for drying the hydrogen gas of the rotary electric machine 1, and the other of the first drying tower 4 or the second drying tower 5 is switched to a reactivation circuit side B for reactivating the first desiccant 6 or the second desiccant 7 provided therein.

The first drying tower 4 is provided with a first heater 8 for reactivating the first desiccant 6. The second drying tower 5 is provided with a second heater 9 for reactivating the second desiccant 7. On the inlet side of the first drying tower 4 and the second drying tower 5, a first four-way valve 10 is provided for switching the first drying tower 4 and the second drying tower 5 between the drying circuit side A and the reactivation circuit side B. On the outlet side of the first drying tower 4 and the second drying tower 5, a second four-way valve 11 is provided for switching the first drying tower 4 and the second drying tower 5 between the drying circuit side A and the reactivation circuit side B.

A reactivation blower 12 for circulating gas is provided on the reactivation circuit side B. A supply unit 13 is provided for controlling and supplying air from the outside of the gas dryer 3. The supply unit 13 can also supply compressed air. The supply unit 13 is provided with a first supply pipe 16 for supplying compressed air to a cooler 14 described later. A first solenoid valve 17 is provided for controlling the air supplied through the first supply pipe 16.

The cooler 14 is provided for generating air (low-temperature air) having a temperature at which moisture in gas on the reactivation circuit side B is condensed. The cooler 14 is based on a vortex principle, and with only compressed air supplied via the first supply pipe 16 from the supply unit 13, ejects low-temperature air at a maximum temperature difference, e.g., −75° C., from the temperature of the compressed air, without using a power supply and chlorofluorocarbon gas.

A discharge unit 15 is provided for discharging water condensed by the cooler 14 to the outside of the gas dryer 3. For the first drying tower 4, a first safety valve 18 for controlling sharp discharge of gas from the inside is provided. For the second drying tower 5, a second safety valve 19 for controlling sharp discharge of gas from the inside is provided. A second solenoid valve 20 is provided for controlling the pressure in the first drying tower 4 or the second drying tower 5 on the reactivation circuit side B. A third solenoid valve 21 is provided for switching the first four-way valve 10 and the second four-way valve 11.

A first temperature measurement element 22 is provided for measuring the temperature of the first heater 8. A second temperature measurement element 23 is provided for measuring the temperature of the second heater 9. A third temperature measurement element 24 is provided for measuring the temperature of the first desiccant 6. A fourth temperature measurement element 25 is provided for measuring the temperature of the second desiccant 7. A first pressure transmitter 26 is provided for measuring the pressure in the first drying tower 4. A second pressure transmitter 27 is provided for measuring the pressure in the second drying tower 5.

A first dew point meter 28 is provided for measuring the dew point on the inlet side of the gas dryer 3. A second dew point meter 29 is provided for measuring the dew point on the outlet side of the gas dryer 3. A exhaust pipe 31 is provided for discharging gas to the outside of the gas dryer 3. A second supply pipe 32 is provided for sending air for operating the first four-way valve 10 and the second four-way valve 11 from the supply unit 13.

Next, operation of the gas dryer 3 of embodiment 1 configured as described above will be described. First, hydrogen gas sealed in the rotary electric machine 1 passes through the first pipe 2, to be sent into the gas dryer 3, and is dried in the gas dryer 3. Then, the hydrogen gas is returned via the second pipe 30 into the rotary electric machine 1 again. The gas dryer 3 includes two towers of the first drying tower 4 and the second drying tower 5.

In use, either the first drying tower 4 or the second drying tower 5 is switched to the drying circuit side A for drying the hydrogen gas of the rotary electric machine 1, and the other of the first drying tower 4 or the second drying tower 5 is switched to the reactivation circuit side B for reactivating the first desiccant 6 or the second desiccant 7 provided therein.

Here, first, it is assumed that the first drying tower 4 has been switched to the drying circuit side A and the second drying tower 5 has been switched to the reactivation circuit side B. Thus, the first drying tower 4 is connected as the drying circuit side A to the rotary electric machine 1 via the first pipe 2 and the second pipe 30. The second drying tower 5 is connected as the reactivation circuit side B for the second desiccant 7 where the cooler 14, the discharge unit 15, the blower 12, and the like are provided.

Therefore, the hydrogen gas sent to the gas dryer 3 is sent to the first drying tower 4 connected to the rotary electric machine 1, by the first four-way valve 10 and the second four-way valve 11. Next, the hydrogen gas sent to the first drying tower 4 is dehumidified by the first desiccant 6 in the first drying tower 4, and the dried hydrogen gas passes through the second pipe 30, to be returned to the rotary electric machine 1.

At this time, if the first desiccant 6 sufficiently dehumidifies moisture in the hydrogen gas, a measurement result of the second dew point meter 29 on the outlet side of the gas dryer 3 indicates a low value. However, if the first desiccant 6 absorbs a large amount of moisture and comes close to an absorption limit, moisture in the hydrogen gas is not fully dehumidified and the hydrogen gas still containing some moisture is sent out from the first drying tower 4, so that a measurement result of the second dew point meter 29 indicates a high value.

When a measurement result of the second dew point meter 29 exceeds a certain value (which can be set as desired), the third solenoid valve 21 is operated to switch the first four-way valve 10 and the second four-way valve 11. As a result, the first drying tower 4 which has been connected as the drying circuit side A to the rotary electric machine 1 is switched to the reactivation circuit side B, while the second drying tower 5 is switched to the drying circuit side A. That is, the second drying tower 5 switched to the drying circuit side A is connected to the rotary electric machine 1 and thus dehumidifies moisture in the hydrogen gas of the rotary electric machine 1 in the same manner as in the above case.

Next, the first drying tower 4 switched to the reactivation circuit side B undergoes reactivation of the first desiccant 6 in the first drying tower 4. First, if a measurement result of the first pressure transmitter 26 provided for the first drying tower 4 indicates a value higher than the atmospheric pressure, the second solenoid valve 20 is opened to discharge the hydrogen gas to the outside of the gas dryer 3 via the exhaust pipe 31, until the measurement result reaches the atmospheric pressure. Then, when the pressure in the first drying tower 4 is lowered to the atmospheric pressure, the second solenoid valve 20 is closed.

Next, the blower 12 is operated to circulate gas on the reactivation circuit side B (the gas on the reactivation circuit side B refers to gas passing through a pipe, a device, and the like on the reactivation circuit side B, and specifically, is hydrogen gas containing moisture), and the first heater 8 is powered on. The temperature of the first heater 8 is controlled to be constant on the basis of measurement results of the first temperature measurement element 22 and the third temperature measurement element 24.

Next, when high-temperature gas heated by the first heater 8 is sent to the first desiccant 6, moisture absorbed in the first desiccant 6 is released into the hydrogen gas, so that the hydrogen gas is humidified. Next, the humidified hydrogen gas is sent to the cooler 14. Next, in the cooler 14, with the compressed air supplied from the supply unit 13, air having such a temperature that can condense moisture in the gas on the reactivation circuit side B (hereinafter, referred to as low-temperature air) is generated. Then, the hydrogen gas is cooled by the low-temperature air in the cooler 14, so that moisture in the hydrogen gas is condensed.

It is noted that, if compressed air containing moisture is used for the cooler 14, there is a possibility that the compressed air freezes when becoming the low-temperature air inside the cooler 14 and thus clogging occurs inside the cooler 14. Therefore, it is necessary to supply compressed air dried to such an extent that clogging will not occur inside the cooler 14.

Then, the condensed water is collected in the discharge unit 15 and discharged to the outside of the gas dryer 3. The hydrogen gas from which moisture has been removed by the cooler 14 is sent to the first drying tower 4 by the blower 12, and is heated by the first heater 8 again, to reactivate the first desiccant 6. After the reactivation operation for the first desiccant 6 is performed for a certain period, the first heater 8, the cooler 14, and the blower 12 are stopped, and the first drying tower 4 waits until being switched to the drying circuit side A again.

As described above, the gas dryer 3 switches the first drying tower 4 and the second drying tower 5 between the drying circuit side A and the reactivation circuit side B, whereby hydrogen gas in the rotary electric machine 1 can be dried at all times.

In the above embodiment 1, a two-tower drying tower is shown as an example of the gas dryer 3. However, without limitation thereto, even in a case of using a drying tower having three or more towers, it is possible to perform the same operation as in the above embodiment 1 by switching any one of the towers to the drying circuit side A and switching another one to the reactivation circuit side B. The same applies to the other embodiment below and therefore the description thereof is omitted as appropriate.

In the above description, the rotary electric machine 1 is shown as an example of an electric device. However, the same operation can be performed for another electric device that uses hydrogen gas for cooling and needs to dry the hydrogen gas. The same applies to the other embodiment below and therefore the description thereof is omitted as appropriate.

The gas dryer according to embodiment 1 configured as described above is a gas dryer for drying hydrogen gas of an electric device in which the hydrogen gas is sealed, the gas dryer including: a first drying tower having a first desiccant provided therein; and a second drying tower having a second desiccant provided therein. Either the first drying tower or the second drying tower is switched to a drying circuit side for drying the hydrogen gas of the electric device, and another of the first drying tower or the second drying tower is switched to a reactivation circuit side for reactivating the first desiccant or the second desiccant provided therein. The gas dryer includes a cooler which is provided on the reactivation circuit side and which, with supply of compressed air, generates air having a temperature that enables condensation of moisture in the hydrogen gas on the reactivation circuit side.

Thus, since each desiccant can be reactivated by the cooler which operates with supply of compressed air, consideration for explosion protection of hydrogen gas is only needed at a minimum level, the structure is simplified, and the cost can be reduced.

### Embodiment 2

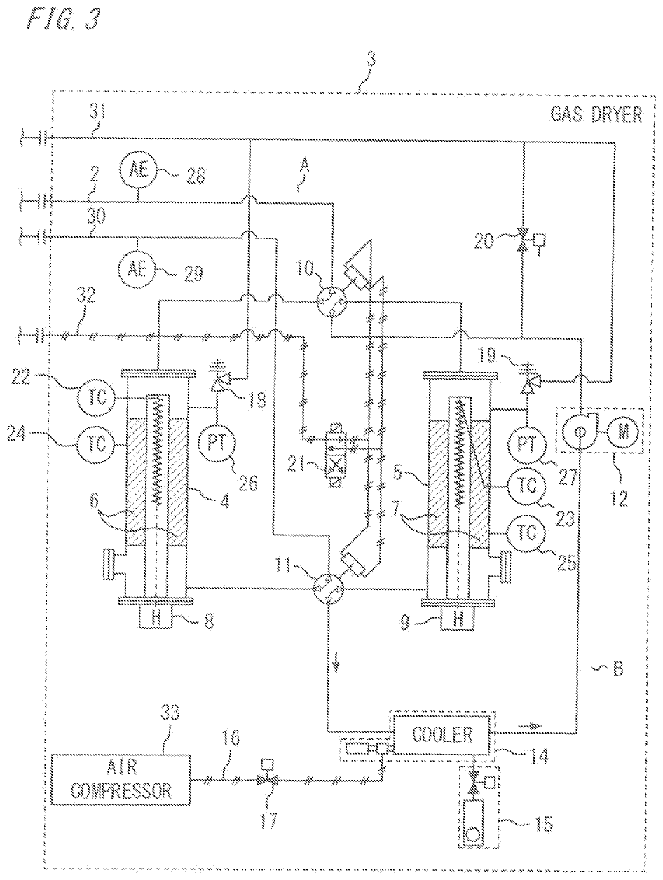

FIG. 3 shows the configuration of a gas dryer according to embodiment 2. In FIG. 3, the same parts as those in the above embodiment 1 are denoted by the same reference characters and description thereof is omitted. In the above embodiment 1, the example in which compressed air to the cooler 14 is supplied from the outside of the gas dryer 3 has been shown. However, without limitation thereto, an air compressor 33 for supplying compressed air to the cooler 14 is provided in the gas dryer 3.

As is also described in the above embodiment 1, if compressed air containing moisture is used for the cooler 14, the compressed air freezes when becoming low-temperature air inside the cooler 14, so that clogging occurs inside the cooler 14. Depending on the environment around the supply unit 13 provided outside the gas dryer 3, there is a case where dry compressed air cannot be supplied. Therefore, in embodiment 2, the air compressor 33 capable of supplying dry compressed air to the cooler 14 is provided in the gas dryer 3. The configurations other than the air compressor 33 are the same as in the above embodiment 1 and the same operation is performed. Therefore, the description thereof is omitted.

With the gas dryer according to embodiment 2 configured as described above, the same effects as in the above embodiment 1 are provided.

In addition, the cooler is provided with an air compressor for supplying the compressed air.

Thus, even in such an environment that compressed air cannot be supplied from the outside, it is possible to easily supply compressed air to the cooler by the air compressor, whereby the gas dryer can be used.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 rotary electric machine
2 first pipe
3 gas dryer
4 first drying tower
5 second drying tower
6 first desiccant
7 second desiccant
8 first heater
9 second heater
10 first four-way valve
11 second four-way valve
12 blower
13 supply unit
14 cooler
15 discharge unit
16 first supply pipe
17 first solenoid valve
18 first safety valve
19 second safety valve
20 second solenoid valve
21 third solenoid valve
22 first temperature measurement element
23 second temperature measurement element
24 third temperature measurement element
25 fourth temperature measurement element
26 first pressure transmitter
27 second pressure transmitter
28 first dew point meter
29 second dew point meter
30 second pipe
31 exhaust pipe
32 second supply pipe
33 air compressor

1. A gas dryer for drying hydrogen gas of an electric device in which the hydrogen gas is sealed, the gas dryer comprising:
a first drying tower having a first desiccant provided therein; and
a second drying tower having a second desiccant provided therein, wherein
either the first drying tower or the second drying tower is switched to a drying circuit side for drying the hydrogen gas of the electric device, and another of the first drying tower or the second drying tower is switched to a reactivation circuit side for reactivating the first desiccant or the second desiccant provided therein, and
the gas dryer includes a cooler which is provided on the reactivation circuit side and which, by a vortex principle using compressed air, generates air having a temperature of which a maximum temperature difference from the compressed air is −75° C. and which enables condensation of moisture in the hydrogen gas on the reactivation circuit side, thus cooling the hydrogen gas, and
the cooler is provided with an air compressor for supplying the compressed air.

2- (canceled)
